(19) United States
(12) Patent Application Publication
(10) Pub. No.: US 2015/0234998 A1
(43) Pub. Date: Aug. 20, 2015

(54) System and Method for Providing Healthcare Services via Telecommunication Networks with Enhanced Interaction between Healthcare Providers and Patients

(71) Applicants: Brian W. Slusser, New Albany, OH (US); Richard J. Scholz, Amelia Island, FL (US); Darren J. Sommer, Dublin, OH (US); Matthew D. Peters, Estero, FL (US)

(72) Inventors: Brian W. Slusser, New Albany, OH (US); Richard J. Scholz, Amelia Island, FL (US); Darren J. Sommer, Dublin, OH (US); Matthew D. Peters, Estero, FL (US)

(73) Assignee: Optimized Care Network, LLC, Columbus, OH (US)

(21) Appl. No.: 14/476,704

(22) Filed: Sep. 3, 2014

Related U.S. Application Data
(60) Provisional application No. 61/873,104, filed on Sep. 3, 2013.

(51) Int. Cl. G06F 19/00; A61G 13/00; A61G 15/10

(52) U.S. Cl. CPC G06F 19/3418; A61G 15/10; A61G 13/0018

(57) ABSTRACT

A system for providing healthcare includes an examination room having a controller configured for communication with a remote healthcare provider, such as a primary care physician, via a telecommunications network, a medical examination chair or table for supporting a patient, and a digital display in communication with the controller and facing the medical examination chair or table. The digital display is configured to display the remote healthcare provider to the patient on the digital display in substantially life size and with direct eye-to-eye contact with the patient. A plurality of digital medical instruments is in communication with the controller for selectively providing diagnostic information of the patient to the remote healthcare provider. An input device is in communication with the controller so that a clinical care coordinator, such as a registered nurse, can selectively control communications between the examination room and the remote healthcare provider.

### CROSS-REFERENCE TO RELATED APPLICATIONS

This application claims the priority of U.S. Provisional Patent Application No. 61/873,104 filed on Sep. 3, 2013, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to systems and methods for providing healthcare services and, more particularly, to systems and methods for providing healthcare services via the Internet or other telecommunications networks.

### BACKGROUND OF THE INVENTION

There exists numerous gaps in the U.S. healthcare system that despite all of our knowledge and technology, thousands of patients are still left sick and dying on a daily basis. The current care models are designed to effectively support 80% of the healthcare market, where the remaining 20% are left unsupported due to economic, social, logistical or educational reasons. To date, there is not a substantial and economically viable solution that can ensure that the remaining 20% of patients receive the same continuous level of exceptional care that the other 80% of patients receive. These 20% of patients fall into what is known as the “healthcare gap.”

The healthcare gap is defined as a break in an expected level of clinical care, due to the current healthcare system being unable to provide a similar level of clinical services as was previously being provided, fostered by a lack of resources (time, money, clinicians, medications, supplies, education, etc.). The healthcare gap leads to poor clinical outcomes and/or higher costs for equivalent care. Examples include: (1) the period of time from a hospital discharge to a return to the patient's baseline level of health; (2) the uninsured or under insured; (3) the period of time when a primary care physician's (PCP) office is closed; (4) the period of time after an emergency department (ED) visit to a return to the patient's baseline level of health; (5) the period of time after surgery to a return to the patient's baseline level of health; (6) the elderly residing in a nursing home; (7) lack of access to specialty care in rural communities (hospital and community based); (8) lack of hospital based specialty clinical coverage 24/7 (radiology, endocrinology, rheumatology); and (9) the complex patient in the traditional PCP practice that utilizes more resources than generates revenue. This is especially true for capitated practices and for patients in the Veterans administration (VA) system

There have been many attempts to solve these problems and many have included various forms of telemedicine. However, patients are often not following “doctor's orders” for many reasons such as, for example, rushed interaction, sick and cannot concentrate, “white coat”, complex instructions, and age. Prior telemedicine solutions have exacerbated some of these issues. Accordingly, there is a need for improved systems and methods for providing healthcare services.

### SUMMARY OF THE INVENTION

Disclosed is a computer implemented system and method for providing healthcare services that overcomes at least some of the disadvantages of the prior art systems described above. Disclosed is a system for providing healthcare comprising, in combination, a controller having a processor and memory and configured for communication with a remote healthcare provider via a telecommunications network, a medical examination support for supporting a patient, and a digital display in communication with the controller and facing the medical examination support. The digital display is configured to display the remote healthcare provider to the patient on the digital display in substantially life size and with direct eye-to-eye contact with the patient. A plurality of digital medical instruments is in communication with the controller for selectively providing diagnostic information of the patient to the remote healthcare provider. an input device is in communication with the controller for selectively controlling communications between the controller and the remote healthcare provider.

Also disclosed is a system for providing healthcare comprising, in combination, an examination room including a controller having a processor and memory and configured for communication with a remote healthcare provider via a telecommunications network, a medical examination support for supporting a patient, and a digital display in communication with the controller and facing the medical examination support. The digital display is configured to display the remote healthcare provider to the patient on the digital display in substantially life size and with direct eye-to-eye contact with the patient. The examination room also includes a plurality of digital medical instruments in communication with the controller for providing diagnostic information of the patient to the remote healthcare provider and an input device in communication with the controller for controlling communications between the examination room and the remote healthcare provider. A remote healthcare provider computer is configured for communication with the controller of the examination room at a location remote from the examination room. The emote healthcare provider computer is configured to provide image information to the controller of the examination room to display the remote healthcare provider to the patient on the digital display in substantially life size and with direct eye-to-eye contact with the patient.

Also disclosed is a method for providing healthcare comprising, in combination, the steps of connecting a controller having a processor and memory in communication with a remote healthcare provider via a telecommunications network, locating a patient on a medical examination support, locating a digital display in communication with the controller facing the medical examination support, displaying the remote healthcare provider on the digital display to the patient in substantially life size and with direct eye-to-eye contact with the patient, providing diagnostic information of the patient to the remote healthcare provider using a plurality of digital medical instruments in communication with the controller, and selectively controlling communications between the controller and the remote healthcare provider using an input device in communication with the controller.

From the foregoing disclosure and the following more detailed description of various preferred embodiments it will be apparent to those skilled in the art that the present invention provides a significant advance in the technology and art of systems and methods of providing healthcare services. Particularly significant in this regard is the potential the invention affords for providing reliable and accurate healthcare at a reduced cost. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a schematic view of a healthcare system according to the present invention.

FIG. 2 is a perspective view of an examination room or care space of the healthcare system of FIG. 1, wherein an on-site care coordinator is located with a patient in the examination room and a remote healthcare provider is working with the patient via a telecommunications network.

FIG. 2A is a perspective view of a second embodiment of an examination room or care space of the healthcare system of FIG. 1.

FIG. 2B is another perspective view of the examination room of FIG. 2A.

FIG. 2C is another perspective view of the examination room of FIGS. 2A and 2B.

FIG. 3 is a schematic view of the examination room of FIG. 2.

FIG. 4 is an elevational view of a digital display in the examination room of FIGS. 2 and 3, wherein the remote healthcare provider is displayed on the digital display in substantially life size and with direct eye-to-eye contact with the patient.

FIG. 5 is an elevational view of the digital display in the examination room similar to FIG. 2, but wherein the display screen is split to display two remote healthcare providers each in substantially life size and with direct eye-to-eye contact with the patient.

FIG. 6 is a perspective view of the remote healthcare provider of the healthcare system of FIG. 1, wherein the healthcare provider is remote from the examination room and has access to the patient via a computer connected to the telecommunications network which provides the patient in the examination room with a display of the remote healthcare provider in substantially life size and with direct eye-to-eye contact.

FIG. 7 is a schematic view of the remote site of the healthcare provider of the remote healthcare of FIG. 6.

It should be understood that the appended drawings are not necessarily to scale, presenting a somewhat simplified representation of various preferred features illustrative of the basic principles of the invention. The specific design features of the components of the healthcare system as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the healthcare system illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods for providing healthcare disclosed herein. The following detailed discussion of various alternative and preferred embodiments will illustrate the general principles of the invention. Other embodiments suitable for other applications will be apparent to those skilled in the art given the benefit of this disclosure.

The system and method according to the present invention provides completely digital examination rooms or care spaces 10 where patients 12 are located and electronically connects the examination rooms 10 to healthcare providers 14 at remote sites 18 via the Internet or other telecommunication networks 18 with a cloud based, HIPAA compliant and encrypted platform. The examination rooms 10 can be at any suitable location such as, for example, a virtual partner's office (a doctor's office) to provide clinical support in large primary care practices, an emergency department as an affordable option to address reducing the overuse of the emergency department for primary care (low acuity cases), and/or work sites as an affordable option to provide on-site delivery of care, assisted living facilities where healthcare is provided to seniors where they live, nursing homes to affordably address the expressed needs of long term care patients, and/or in the community such as at community centers, governments, schools, and universities.

The illustrated network of health care providers includes physicians (primary care and specialists), and allied health professionals (including nurse practitioners/PA's, pharmacists, registered dieticians, life coaches, behavioral health counselors, nutritionists, and social workers). Comprehensive healthcare can be delivered to the patients 12 via the clinical presence of an on-site care coordinator 20 (typically a registered nurse).

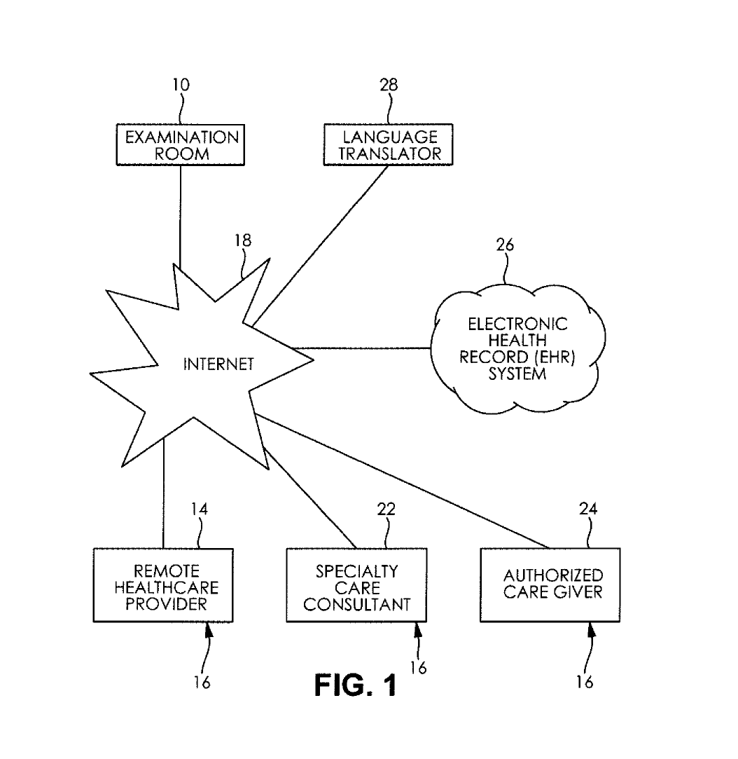

FIG. 1 illustrates a system and method for healthcare according to the present invention. The illustrated system for providing healthcare includes the examination room 10 in communication with the remote health care provider 14 at the remote site 16 via the telecommunication network 18 such as, for example, the Internet. The illustrated health care provider 14 is a primary care physician but can alternatively be any other suitable type of health care provider. The illustrated examination room 10 is also selectively in communication with a specialty care consultant 22, and an authorized care giver 24. While a single remote healthcare provider 14, specialty care consultant 22, and authorized care giver 24 are shown for illustration purposes, any quantity and/or combination of the remote health care provider 14, the specialty care consultant 22, and the authorized care giver 24 can selectively be in communication with the examination room 10 as described in more detail hereinbelow. It is also noted that any other suitable type of medical professional can alternatively be selectively in communication with the examination room 10.

The illustrated remote healthcare provider 14 and any specialty care consultants 22 are also selectively in communication with an electronic health record (EHR) system 26. Access to the EHR system 26 provides the primary care physician 14 and any specialty consultants 22 with stored records associated with the patient. It is noted that the EHR can be of any suitable type that is HIPAA compliant. A suitable cloud based HER system is available from athenahealth, Inc. of Watertown, Mass.

The illustrated examination room 10 is also selectively in communication with an online video translation or interpreter service 28 so that a foreign language interpreters or American Sign Language (or other language for the hearing impaired) interpreters can be utilized in real-time during a video conference when needed for the patient that has limited English proficiency, is deaf, or hard of hearing. As described in more detail hereinbelow, the translator and/or interpreter can be displayed alongside the remote healthcare provider to the patient. A suitable Internet based language translation system is available from Language Access Network of Columbus, Ohio

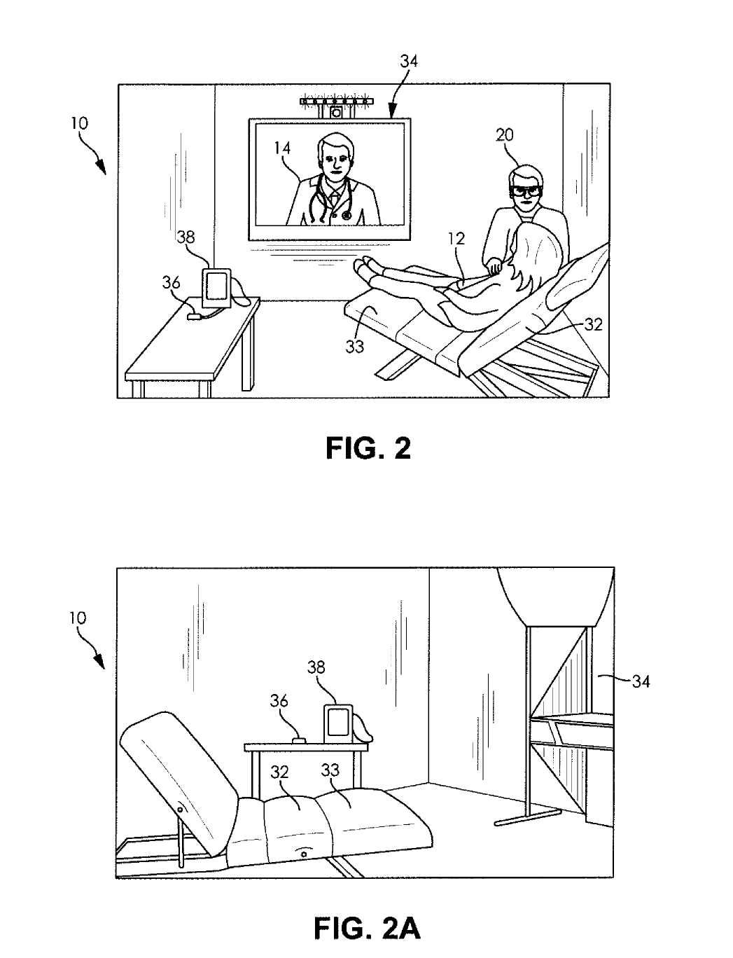

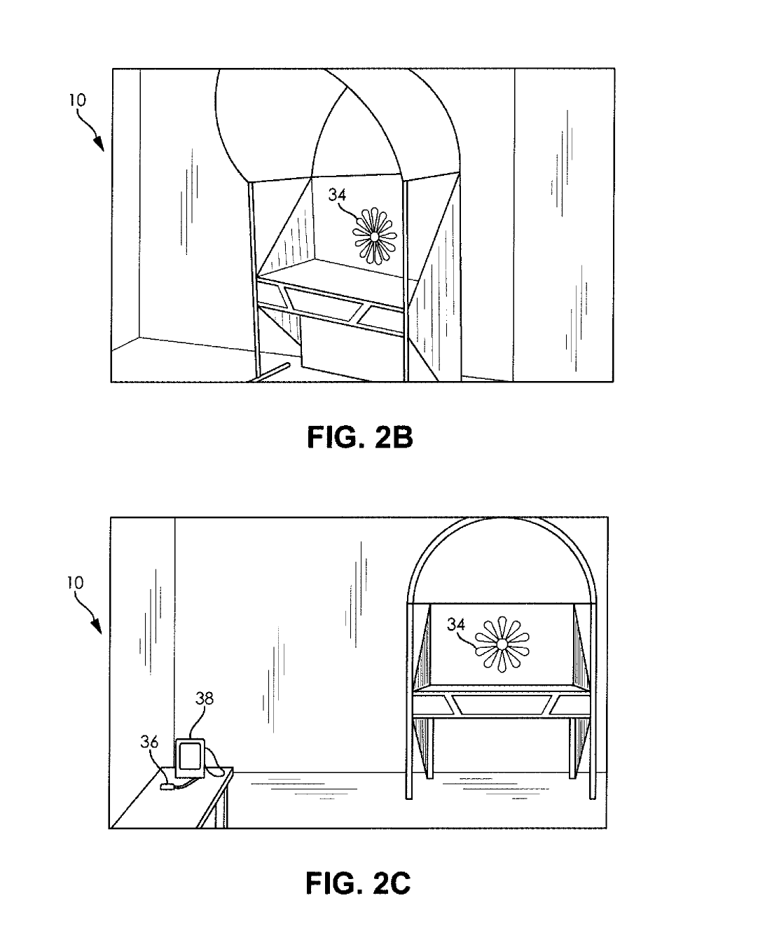

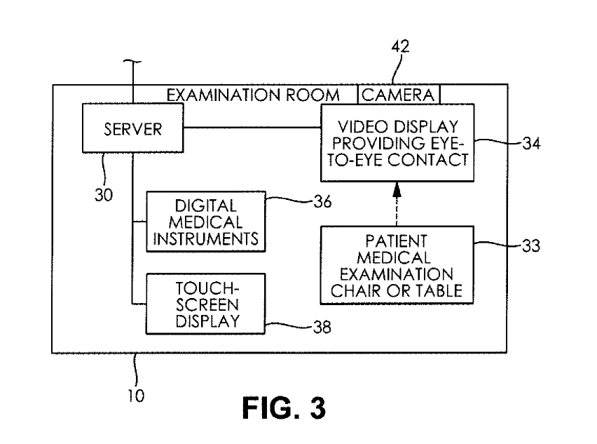

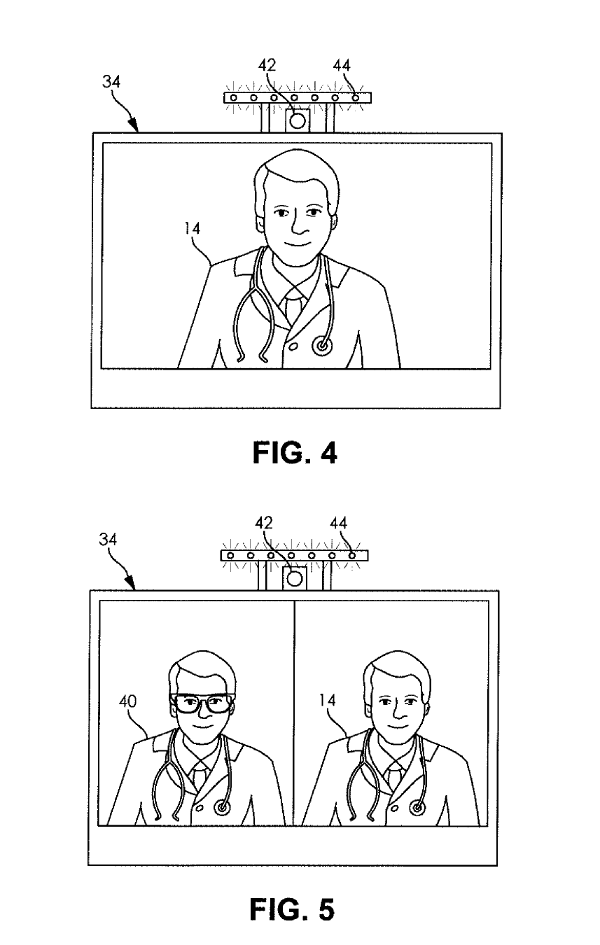

As best shown in FIGS. 2 to 4, the illustrated examination room 10 includes a controller or server 30 having a processor and memory and configured for communication with the remote healthcare provider 14 via the telecommunication network 18, a medical examination support 32 for supporting a patient, a digital video display 34 in communication with the controller 30 and facing the medical examination support 32, a plurality of digital medical instruments 36 in communication with the controller 30 for selectively providing diagnostic information (including sounds and images) of the patient to the remote healthcare provider 14, and an input device 38 in communication with the controller 30 for selectively controlling communications between the controller 30 and the remote healthcare provider 26 etc. . . . . The digital display 34 is configured to display the remote healthcare provider 14 to the patient 12 on the digital display 34 in substantially life size and with direct eye-to-eye contact with the patient 12. The illustrated examination room 10 is also provided with suitable acoustic panels to ensure privacy of the patient 12 by preventing sounds from exiting the examination room 10.

The illustrated controller or server 30 includes a processor and memory programmed with computer software for carrying out the method for providing healthcare according to the present invention. The illustrated server 30 is located at the examination room 10 and can be accessed and operated by the on-site care coordinator (such as a registered nurse) 20, located at the examination room 10. It is noted that while the illustrated software is provided at the examination room 10, the software can alternatively can be located at any other suitable location such as, for example, a cloud server, a service provider, or the like. The illustrated communication system is the telecommunication network 18 such as, for example, the Internet but any other suitable communication system can alternatively be utilized such as, for example, and intranet or any other network of computers. The computers and/or servers can be any electronic device that can suitably communicate via the communication system including, but not limited to, desktop computers, laptop computers, notebook computers, tablet computers, smart telephones, personal digital assistants (PDAs), digital cameras, mp3 players, video game systems, messaging systems, video players, smart televisions, and the like.

FIG. 2 illustrates the remote healthcare provider 14 located at the remote site 16 working with the on-site care coordinator 20 located at the examination room 10. The on-site care coordinator 20 is typically a registered nurse and facilitates provider interaction at the examination room 10 as described in more detail hereinbelow.

The illustrated medical examination support 32 is located within the examination room 10 for supporting a patient 12 in either a seated or laying manner during a medical examination. The medical examination support 32 can be one or more of a medical examination chair, medical examination table, or the like. It is noted that any suitable type of medical examination support 32 can be utilized.

The illustrated digital display 34 is located within the examination room 10 and is in communication with the controller 30 by suitable wired or wireless connection. The illustrated digital display 34 faces a front or foot end 33 of the medical examination support 32 so that the patient 12 can directly view the digital display 34 when sitting and/or laying on the medical examination support 32. The illustrated digital display 34 is a high definition digital display and more specifically a 3D digital display. It is noted that the digital display 34 can be of any suitable type of digital video display such as, for example, a LCD digital video display. The illustrated controller 30 and the digital display 34 are configured to display a substantially life size image of the remote healthcare provider 14 to the patient 12 on the digital display 34. The term “substantially life size” is used in this specification and the claims to mean a size that is life size or close to life size so that the patient 12 perceives the image of the remote healthcare provider 14 to be life size.

Direct eye-to-eye contact technology is provided so that the digital display 34 shows an image of the remote healthcare provider 14 directly looking at the patient 12 with direct eye-to-eye contact. That is, the remote healthcare provider 14 displayed on the digital display 34 is viewed by the patient 12 with direct eye-to-eye contact. The direct eye-to-eye contact technology can be of any suitable type. Suitable providers of direct eye-to-eye contact technology include Telepresence Technologies, LLC of Plano, Tex., Digital Video Enterprises, Inc. of Santa Ana, Calif., Bodelin Technologies of Lake Oswego, Oreg., SeelTOl of Dallas, Tex., ETH Zurich of Zurich, Switzerland, and Fraunhaufer Heinrich Hertz Institute of Berlin, Germany. For an example of suitable eye-to-eye contact technology see U.S. Pat. Nos. 8,599,239, 8,520,064, 8,300,785, 8,208,007, 7,760,229, and U.S. Patent Publication Number 2012/0229592 A1, the disclosures of which are expressly incorporated herein in their entireties by reference. Additionally, at least one of a height of the medical examination support 32 and a height of the digital display 34 is adjustable so that the remote medical provider 14 can be displayed on the digital display 34 at substantially eye level with the patient 12.

It is believed that while social touch and length of visit can play a role in a patient's perception of doctor empathy, the amount of eye contact the doctor makes with the patient is the most important factor for patients. A simple think like direct eye contact can have a big impact because if patients feel that their doctors are not being empathetic, than the patients are more likely to not return to care, not adhere to medical advice, not seek future care, and/or switch providers (which is very costly for the healthcare system). See for example, “Immersive Group Telepresence and the Perception of Eye Contact”, by Steve McNelly, Ph.D., and “The Importance of Eye-Contact in Visual Communications” by David Danto, the disclosures of which are expressly incorporated herein in their entireties by reference.

As best shown in FIG. 5, the illustrated digital display 34 is configured so that the digital display 34 can be split to display the remote healthcare provider 14 and another person 40 (such as a specialty care consultant 22 or an authorized care giver 24) in a laterally side-by-side manner with the remote healthcare provider 14 and the another person 40 each displayed to the patient 12 in substantially life size and with direct eye-to-eye contact with the patient 12. The split screen can display, for example, primary care physician 14 with a specialty care consultant 22, a primary care physician 14 and a language translator 28, a primary care physician 14 and an authorized care giver 24, a primary care physician 14 and a diagnostic image, or the like.

The illustrated examination room 10 is also provided with a high definition (HD) video camera 42 in communication with the controller 30 by suitable wired or wireless connection. The HD video camera 42 is positioned and configured to provide the remote healthcare provider 14 with video images of the patient 12 located on the medical examination support 32. It is noted that the HD video camera 42 can alternatively be of any other suitable type. The illustrated examination room 10 is also provided with lights 44 directed toward the patient 12 to provide suitable images of the patient 12 via the HD video camera 42. Direct eye-to-eye contact technology is preferably provided so that the remote healthcare provider 14 sees a video image of the patient 12 directly looking at them with direct eye-to-eye contact as described above in the reverse direction. It is noted that the HD video cameras 42 in the examination room 10 as well as the HD video camera 42 at the remote site 16 include microphones for providing digital sound as well as digital video images so that the remote healthcare provider 14 appears and sounds like he/she is in the examination room 10 and the patient appears and sounds like he/she in at the remote site 16.

The illustrated plurality of digital medical instruments 36 in communication with the controller 30 via wired or wireless communication for selectively providing diagnostic information of the patient to the remote healthcare provider 14. The illustrated digital medical instruments 36 can send real-time patient data to the remote healthcare provider 14 such as, for example, weight, blood pressure, pulse, temperature, images etc. Images provided to the remote healthcare provider 14 can be annotated and stored for future reference. The illustrated plurality of digital medical instruments 36 includes a stethoscope, an otoscope, an opthalmoscope, a dermatoscope, a fundus camera, and a vital signs station. It is noted, however, that any other suitable combination of the digital medical instruments 36 can be utilized and/or any other suitable digital medical instruments 36 can alternatively be utilized. Some suitable digital medical instruments are available from JEDMED of St. Louis, Mo.

The illustrated input device 38 is in communication with the controller 30 via a wired or wireless connection for selectively controlling communications between the controller 30 and the remote healthcare provider 14 as described in more detail hereinbelow. The illustrated input device 34 is a touch pad or screen but it is noted that any other suitable input device or devices can alternatively be utilized. A suitable touch pad is available from Crestron Electronics, Inc. of Rockleigh, N.J.

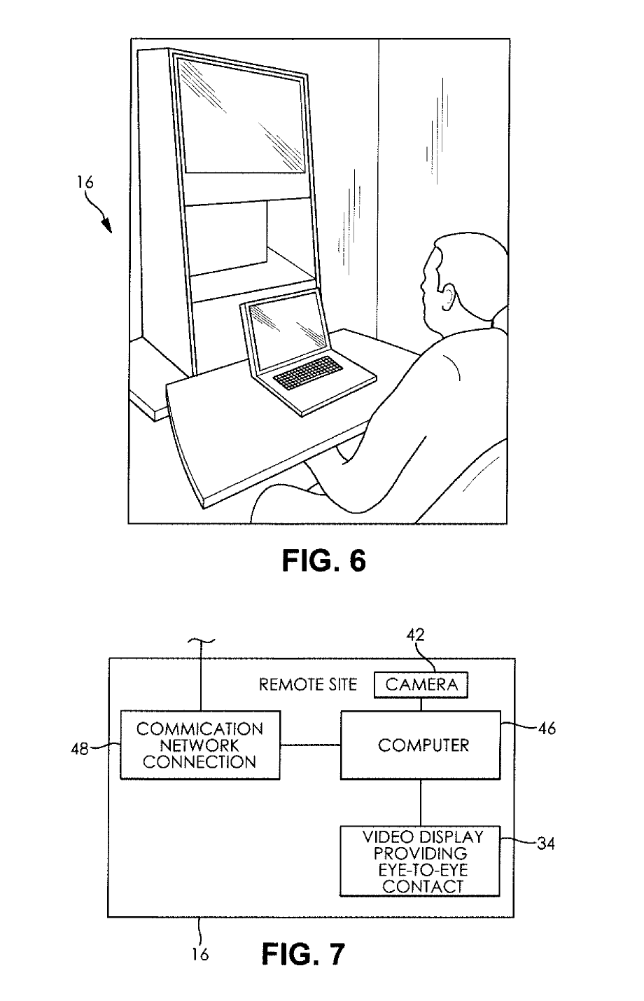

As best shown in FIGS. 6 and 7, the illustrated remote site 16 for the remote healthcare provider 14, specialty care consultant 22 etc. includes a remote healthcare provider computer 46 configured for communication with the controller 30 of the examination room 10, the EHR system 26 etc. and a communication network connection 48 for communication via the telecommunication network 18. The illustrated remote healthcare provider computer 46 is provide with a HD video camera 42 and is configured to provide video image information to the controller 30 of the examination room 10 to display the remote healthcare provider 14 to the patient 12 on the digital display 34 in substantially life size and with direct eye-to-eye contact with the patient 12 as described hereinabove and is also configured to provide the remote healthcare provider 14 with images and patient information from the HD video camera 42 and the digital medical instruments 46 located in the examination room 10. The remote healthcare provider computer 46 can be of any suitable type including a desk top computer (best shown in FIG. 6) and a laptop, a tablet computer, and the like.

Each examination room 10 is provided with a patient software system stored on the controller 30 and interfaced through the touch screen 38 through which the on-site care coordinator 20 can coordinate the flow of information. The patient software system is designed to be operated by a nurse with no IT training. The user interface of the patient software system anticipates the needs of the end-user during system operation. At any given time, the on-site care coordinator 20 is intuitively presented with the most logical and common choices to aid in ease of use. At the core of the patient software system functionality are two main activities displayed on the home page from which the users can drill down to their desired result. These two activities are (1) Remove Privacy Mode, and (2) Accept or Make Call. In addition, the entry home page has a “hidden” button that allows direct access to an advanced dialing page.

Automation.

Every patient software system has some automation that anticipates the most common user needs allowing for simplification of the system controls. The following automation features are preferably active:
Auto Shutdown—when the system is unused for a predetermined time such as, for example, 15 minutes, the system will automatically shut off the display, mute the camera, and enable “privacy” mode so that the system cannot be “dialed into” accidentally.
FusionRV—the system is registered to the FusionRV Server allowing remote monitoring of system, devices status, error monitoring and consumable lifespan.
X-Panel—an X-Panel is created for the system so that remote users are able to provide support and manage system functions without being in the examination room. (X-Panel functionality is exactly the same as the touch panel in the examination room).

System Controls.

The touch panel control system is designed for a typical patient and doctor consultation with a minimum of intervention by the on-site care coordinator located in the examination room. The following are the basic controls that preferably available as part of the touch screen for the on-site care coordinator located in the examination room.
System Wake Up—upon arrival in the examination room, the system will awaken when it detects motion near the touch panel, or the on-site care coordinator will touch the surface of the touch panel to awaken the touch panel, and the system. This will turn on the LCD screen of the touch panel, and select the LCD input that shows the media player showing welcome content. The system will remain in conference privacy mode until it is made available for connection by the on-site care coordinator.
Available for Consult/Remove Privacy Mode—upon selecting this option the system will switch the LCD display to the conferencing input. The patient and the on-site care coordinator will see a black screen. The system will display a black screen from an unused input until the VC system call is initiated. The remote healthcare provider side will proceed with dialing the examination room, and the on-site care coordinator will touch the accept button to accept a call. The call will then complete, and the LCD display will show the remote end (remote healthcare provider) on the screen (video unmute). The patient will be able to see and hear the remote healthcare provider. The video conferencing menu is not seen by the patient in the examination room.

In Consult/Conference Controls.

During a conference/consultation, the on-site care coordinator is able to use the touch screen to operate the conference and display system. The following control will be available during a conference:
Show Computer Content—this button displays the computer display that is connected via DVI to the Codec. The computer image will be shown full screen on both the local display in the examination room, and to the remote healthcare provider on the remote end of a consultation. Pressing the button again will return to the normal display mode.
Audio/Video Mute—this button allows the on-site care coordinator to mute both the audio and video being sent to the remote end. This feature enhances privacy and security.
Camera Controls Buttons—these buttons allow the on-site care coordinator to adjust the camera view for the camera in the examination room. This allows the on-site care coordinator to zoom the camera in to show a particular area of concern for the patient. During camera adjustment, a small pop-up will appear on the main LCD screen showing the local camera, so that the patient and the on-site care coordinator can see to allow the adjustments to be made. A button on the touch panel also allows picture-in-picture (PIP) to be activated or de-activated.
End Call Button—upon selecting this option, a confirmation button appears confirming that the patient and the on-site care coordinator want to end the call. The system will end the consult/conference with the remote healthcare provider when the button is activated. The system will immediately switch the LCD display to the input showing the media player. It will also immediately put the conference system into the privacy mode. After pressing this button, the touch screen will return to the home page. If the remote side ends the call, the display will go black, and a pop up on the touch panel will show the far side has disconnected. An OK button will appear on the touch panel to acknowledge the disconnection.

Advanced User Mode.

Advanced User Mode is for systems administrators to be able to control individual devices and use more advance features that could be more intimidating to average users. This page is hidden to reduce the potential for user confusion. To launch this page, the user presses and holds the network icon for 10 seconds. In this mode users are presented with the following options:
Display Input Control—the user is able to manually select the video conferencing (VC) or media player input.
Video Conference Advanced controls—the user is able to display the VC system menu on the local LCD screen to allow advanced adjustments and navigation with the VC system. Users have the ability to manually dial a call and have short cut access to the directory on the LCD display for the VC system codec.
System Management Status—Users are able to see the status of the local IP devices, Showing Green or Red status.
   Power Distribution Unit—Power at PDU is good.
   Codec—Codec responding and no error messages
   Display—Display is on and no error messages
   Amplifier—Is on
   Network—If we can draw info from Cisco that WAN is connected, or at least Crestron is seeing Fusion Server, and able to see UVC Server
System Management—As a selection on the System Management Status, there is a System Management Button. This button is password protected and allows access to connect to the IP power strip and force power cycle on Codec, on room PC, on Amplifier, on Display, on router, and on Crestron.

Server Monitoring.—

Fusion RV server is configured to detect and monitor as much as possible from the site perspective. Proactive fault detection is set to maximum. This includes, and is not limited to:
Crestron Processor—Any faults or inactivity of processor itself, Alert if off line.
Touch Panel—Status, Alert if off line or locked up.
LifeSize Icon—Codec responding and no error messages, Poll and record in call statistics. Connection speed, connection to, average packet loss, etc. Set thresholds for alerts when off line, errors reporting, or call threshold drops below 512K or >8% packet loss.
Power Distribution Unit—Power at PDU is good, Power draw for each component on PDU. (Devices are on that are supposed to be, including PC) Alert when items are off, or if power fluctuations (spikes/brownouts) occur.
Display—Display is on and no error messages, see what input is active, and alert power or system error codes, such as fan or power supply errors.
Amplifier—Is on, sound level, source detection, speaker detection. Alert any errors or off line
Network—Basic Info to be drawn from Cisco on traffic and addresses.

The network is supported and monitored by a remote IT group. The system has thresholds that when exceeded trigger alarms. The remote managers can access and control everything in the examination room.

The on-site care coordinator 20 can initiate a call with the remote healthcare provider 14 via the controller 30 using the touch screen 38. The HD video camera 42 can be used to take an image of the patient 12 at a relevant body location. The image can be stored and annotated by the remote healthcare provider 14. The image is displayed but the digital display 34 in the examination room 10 preferably does not split the screen with an image of the remote healthcare provider 14 so that remote healthcare provider 14 does not distract the patient from viewing the image. However, they can be displayed on a split screen if desired. The on-site care coordinator 20 and the patient 12 can speak over the displayed image but cannot see the remote healthcare provider 14 at this time. The remote healthcare provider 14 has access to the record system 26 and a consulting physician or specialty care consultant 22 can access the records in the record system 26 to give an opinion. The on-site care coordinator 20 can also take and send other data to the remote healthcare provider 14 as required and directed by the remote healthcare provider 14 such as through the digital medical instruments 36 like the otoscope, stethoscope etc.

It is noted that each of the features and variations of the above disclosed embodiments can be used in any combination with each of the other embodiments.

From the foregoing disclosure it is apparent that the disclosed systems and methods for providing healthcare according to the present invention will provide increased perception of doctor empathy and thus improved healthcare and reduced healthcare costs.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A system for providing healthcare comprising, in combination:
a controller having a processor and memory and configured for communication with a remote healthcare provider via a telecommunications network;
a medical examination support for supporting a patient;
a digital display in communication with the controller and facing the medical examination support;
wherein the digital display is configured to display the remote healthcare provider to the patient on the digital display in substantially life size and with direct eye-to-eye contact with the patient;
a plurality of digital medical instruments in communication with the controller for selectively providing diagnostic information of the patient to the remote healthcare provider; and
an input device in communication with the controller for selectively controlling communications between the controller and the remote healthcare provider.

2. The system for providing healthcare according to claim 1, wherein the medical examination support is one of a medical examination chair and a medical examination table.

3. The system for providing healthcare according to claim 1, wherein the digital display faces a front of the medical examination support.

4. The system for providing healthcare according to claim 1, wherein the digital display is a high definition digital display.

5. The system for providing healthcare according to claim 1, wherein the digital display is a 3D digital display.

6. The system for providing healthcare according to claim 1, wherein the digital display is configured so that the digital display can be split to display the remote healthcare provider and another person in a side by side manner with the remote healthcare provider and the another person each displayed to the patient in substantially life size and with direct eye-to-eye contact with the patient.

7. The system for providing healthcare according to claim 1, wherein at least one of a height of the medical examination support and a height of the digital display is adjustable so that the remote medical provider can be displayed on the digital display at eye level of the patient.

8. The system for providing healthcare according to claim 1, wherein the plurality of digital medical instruments includes a stethoscope, an otoscope, an opthalmoscope, a dermatoscope, and a fundus camera.

9. The system for providing healthcare according to claim 1, wherein the plurality of digital medical instruments further includes a vital signs station.

10. The system for providing healthcare according to claim 1, wherein the input device is a touch screen.

11. A system for providing healthcare comprising, in combination:
an examination room including:
a controller having a processor and memory and configured for communication with a remote healthcare provider via a telecommunications network;
a medical examination support for supporting a patient;
a digital display in communication with the controller and facing the medical examination support;
wherein the digital display is configured to display the remote healthcare provider to the patient on the digital display in substantially life size and with direct eye-to-eye contact with the patient;
a plurality of digital medical instruments in communication with the controller for providing diagnostic information of the patient to the remote healthcare provider; and
an input device in communication with the controller for controlling communications between the examination room and the remote healthcare provider;
a remote healthcare provider computer configured for communication with the controller of the examination room; and
wherein the remote healthcare provider computer is configured to provide image information to the controller of the examination room to display the remote healthcare provider to the patient on the digital display in substantially life size and with direct eye-to-eye contact with the patient.

12. The system for providing healthcare according to claim 11, wherein the medical examination support is one of a medical examination chair and a medical examination table.

13. The system for providing healthcare according to claim 11, wherein the digital display faces a front of the medical examination support.

14. The system for providing healthcare according to claim 11, wherein the digital display is a high definition digital display.

15. The system for providing healthcare according to claim 41, wherein the digital display is a 3D digital display.

16. The system for providing healthcare according to claim 11, wherein the digital display is configured so that the digital display can be split to display the remote healthcare provider and another person in a side by side manner with the remote healthcare provider and the another person each displayed to the patient in substantially life size and with direct eye-to-eye contact with the patient.

17. The system for providing healthcare according to claim 11, wherein at least one of a height of the medical examination support and a height of the digital display is adjustable so that the remote medical provider can be displayed on the digital display at eye level of the patient.

18. The system for providing healthcare according to claim 11, wherein the plurality of digital medical instruments includes a stethoscope, an otoscope, an opthalmoscope, a dermatoscope, and a fundus camera.

19. The system for providing healthcare according to claim 11, wherein the input device is a touch screen.

20. A method for providing healthcare comprising, in combination:
connecting a controller having a processor and memory in communication with a remote healthcare provider via a telecommunications network;
locating a patient on a medical examination support;
locating a digital display in communication with the controller facing the medical examination support;
displaying the remote healthcare provider on the digital display to the patient in substantially life size and with direct eye-to-eye contact with the patient;
providing diagnostic information of the patient to the remote healthcare provider using a plurality of digital medical instruments in communication with the controller; and
selectively controlling communications between the controller and the remote healthcare provider using an input device in communication with the controller.
